(19) United States
(12) Patent Application Publication
(10) Pub. No.: US 2002/0148656 A1
(43) Pub. Date: Oct. 17, 2002

(54) Dual motor driving control system of electrical vehicle

(76) Inventor: Shu-Hsien Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/833,691

(22) Filed: Apr. 13, 2001

(51) Int. Cl. B62D 6/00

(52) U.S. Cl. 180/6.2; 180/220

(57) ABSTRACT

A dual motor driving control system is incorporated in an electrical vehicle having a front wheel and a rear wheel. The control system includes first and second motors respectively and mechanically coupled to the front and rear wheels of the vehicle for separately driving the wheels. A central control device includes a single chip microprocessor executing control software to selectively perform at least one predetermined motor control model. The central control device has output control units electrically coupled to the motors to control operations of the motors based on the motor control model performed in the mircroprocessor.

### FIELD OF THE INVENTION

The present invention generally relates to an electrical vehicle, such as an electrical bicycle, and in particular to a system for simultaneously controlling two motors respectively coupled to front and rear wheels of a two-wheel electrical vehicle.

### BACKGROUND OF THE INVENTION

In the modem trend of environmental protection, electrical vehicles have been commonly used in short distance transportation. Electrical bicycle or electrical motorcycles are one of the most popular electrically-assisted personal transportation means. The most important parts of an electrical bicycle or electrical motorcycle is an electrical motor which servers as a torque source for driving the electrical bicycle or the electrical motorcycle. Controlling the operation of the motor is a key factor in determining the overall efficiency of a two-wheel electrical vehicle.

In a conventional electrical bicycle or electrical motorcycle, the motor is mounted to a frame of the bicycle or the motorcycle and mechanically coupled to one wheel of the bicycle or the motorcycle. Since the motor itself is of a substantial weight, mounting a single motor in a bicycle frame usually results in improper shift of the overall weight center. A conventional way for mounting a motor to a bicycle frame is to mount the motor at the location of pedals of the bicycle. In this way, the portions of the bicycle frame that are adjacent the pedals are subject to greater load, causing difficult in handling/operating the bicycle.

Furthermore, since a single motor system can only provide torque to one wheel, such as the rear wheel of a bicycle, with the aid of a transmission system, such as a chain and sprocket system. Such an arrangement is not suitable for a bicycle moving in different road conditions or environments. For example, when a bicycle in moving uphill, simply driving the rear wheel with the motor does not provide a sufficient torque to really help moving the bicycle upward. Such a situation also causes unnecessary waste of electricity, leading to undesired over-discharge of a battery set supplying power to the motor.

In addition, such an arrangement causes an instantaneous large torque at the rear wheel in an uphill condition. The instantaneous large torque may lead to force unbalance between the front and rear wheels causing unstable operation of the bicycle.

Conventionally, the motor of an electrical bicycle is controlled by a switch mounted in a handle of the bicycle. Such a switch function to switch the motor between ON and OFF states. In other words, once the motor is turned on, the motor operates at its full output condition. Thus the torque applied to the rear wheel by the motor is in fact not regulated and properly adjusted. This certainly causes a waste of power. For example, when the bicycle is just to start, a great initial torque is required. However, when the bicycle is moving downhill, or moving in a horizontal surface, only a small torque or completely no torque is needed. The different requirement of torque in different operation condition make it necessary to regulate the motor output in accordance with the operation condition of the bicycle.

Examples of electrical bicycles are disclosed in U.S. Pat. No. 5,749,429 and European Patent No. 0636537A1. The electrical bicycles disclosed in these patents have a conventional structure as discussed above thereby suffering the same disadvantages, such as improper distribution of overall weight and poor control of motor output.

Taiwan Patent Publication Nos. 238811 and 207219 disclose “rim motor” directly mounted in either front wheel or rear wheel of an electrical bicycle. This, although solving the weight distribution problem, does not really meet the torque requirement for different operation conditions of a bicycle. Thus they have the same problems as other conventional designs, namely waste of power and causing damage to the users.

Thus, it is desired to provide a dual motor driving control system for solving the problems discussed above.

### SUMMARY OF THE INVENTION

Accordingly, an object of the present invention is to provide a dual motor driving control system comprising two motors respectively mounted in front and rear wheels of a two-wheel electrical vehicle whereby both the front and rear wheels of the vehicle are independently provided with additional torque to assist in moving the bicycle in different operation conditions.

Another object of the present invention is to provide a dual motor driving control system comprising two motors respectively mounted in front and rear wheels of a two-wheel electrical vehicle wherein the control system incorporates a closed-loop feed control for precisely controlling torque applied to the front and rear wheels and thus achieving a stable operation of the vehicle through different operation conditions.

A further object of the present invention is to provide a dual motor driving control system comprising two motors respectively mounted to front and rear wheels of a two-wheel electrical vehicle, the outputs of the two motors being precisely regulated to achieve an efficient operation of the bicycle and preservation of the power supplied to the motors.

To achieve the above objects, in accordance with the present invention, a dual motor driving control system comprising first and second motors respectively and mechanically coupled to front and rear wheels of a two-wheel vehicle for separately driving the wheels. A central control device comprises a single chip microprocessor executing control software to selectively perform at least one predetermined motor control model. The central control device has output control units electrically coupled to the motors to control operations of the motors based on the motor control model performed in the microprocessor.

### BRIEF DESCRIPTION OF THE DRAWINGS

The present invention will be apparent to those skilled in the art by reading the following description of preferred embodiments with reference to the attached drawings, in which:

FIG. 1 is a system block diagram of a dual motor driving control system in accordance with the present invention;

FIG. 2 is a plot showing an example of the overall motor output of front wheel motor and rear wheel motor under the control of a central control device of the dual motor driving control system of the present invention;

FIG. 3 is a plot similar to FIG. 2 but showing another example of the overall motor output of the front wheel motor and the rear wheel motor;

FIG. 4 is a plot showing the relationship between the motor output torque and moving speed of a bicycle;

FIG. 5 is a schematic view showing a first application of the dual motor driving control system of the present invention;

FIG. 6 is a schematic view showing a second application of the dual motor driving control system of the present invention; and

FIG. 7 is a schematic view showing a third application of the dual motor driving control system of the present invention.

### DETAILED DESCRIPTION OF THE PREFERRED EMBODIMENTS

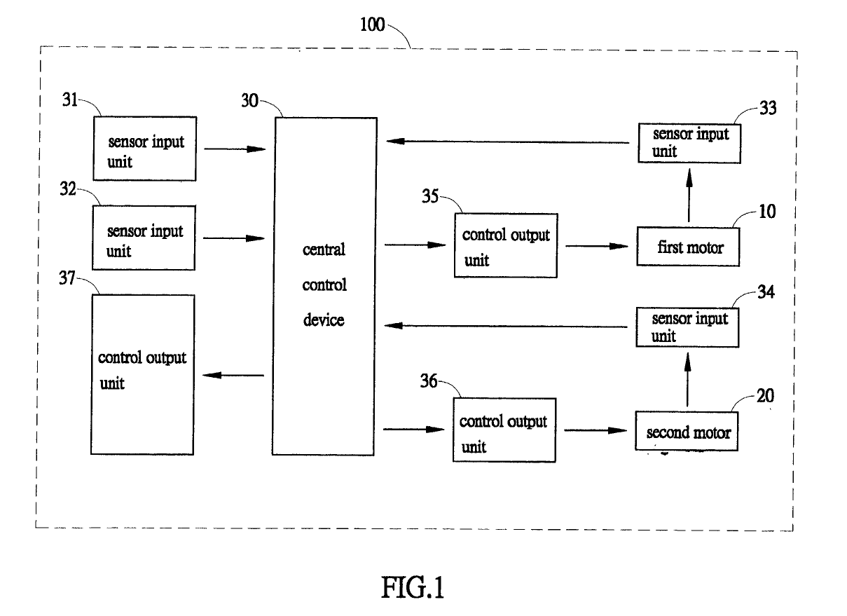

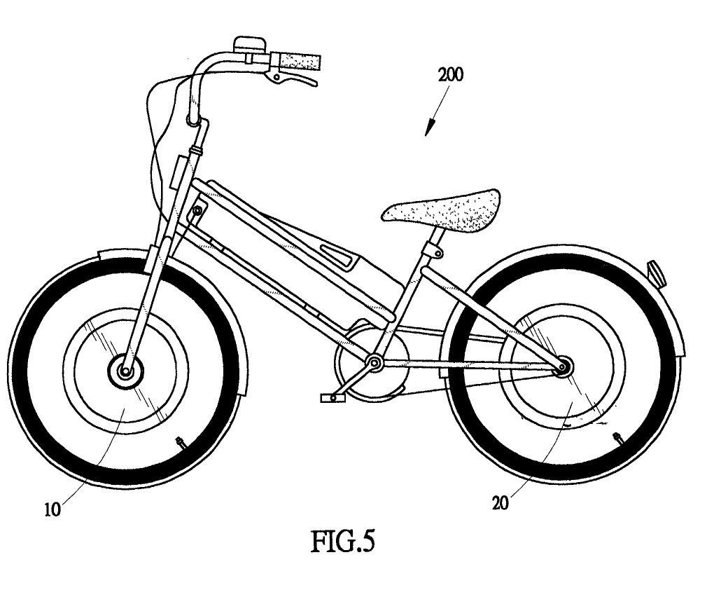

With reference to the drawings and in particular to FIG. 1, a dual motor driving control system in accordance with the present invention, generally designated with reference numeral 100, comprises a first motor 10 and a second motor 20 for being respectively mounted to front and rear wheels of a two-wheel electrical vehicle, such as an electrical bicycle, an electrical scooter and an electrical motorcycle respectively shown in FIGS. 5-7. Preferably, the motors 10, 20 are rim motors which can be directly mounted in the wheels. By mounting two motors 10, 20 in both the front and rear wheels of a two-wheel vehicle, a balance of weight distribution is obtained.

The dual motor driving control system 100 comprises a central control device 30. The central control device 30 may be of any suitable type. An example of the central control device 30 is a single chip microprocessor incorporating/executing suitable control software therein. The central control deice 30 has sensor input units 31, 32, 33, 34 and control output units 35, 36, 37. The sensor input units 31, 32, 33, 34 respectively function to detect fuel valve opening, pedaling torque, meter readings (including speed, mileage, battery status), and rotational speeds, output torque and temperature of the first and second motors 10, 20. For example, in the case of an electrical motorcycle which, besides an electrical motor, includes a fossil fuel engine operated by fossil fuel, a fuel valve or the likes being incorporated in the fossil fuel engine to control fuel supplied thereto, the sensor input unit 31 detects the fuel valve opening of the engine, while in the case of an electrical bicycle, the sensor input unit 31 detects pedaling torque that a rider applies to the bicycle. The detection of the fuel valve opening or the pedaling torque provides an indication of the operation condition of the electrical motorcycle or the electrical bicycle. When the electrical motorcycle or electrical bicycle is moving uphill, the fuel valve of the electrical motorcycle opens wide or the pedaling torque of the electrical bicycle becomes large. A corresponding signal is thus fed into the sensor input unit 31 to be transmitted to the central control device 30.

The sensor input unit 32 detects and/or receives meter readings from the electrical motorcycle or electrical bicycle, such as speed and mileage. The readings are fed into the central control device 30. The central control device 30 is programmed to operate the motors 10, 20 based on the readings and the signal from the sensor input unit 31. In accordance with the present invention, the central control device 30 is also programmed to provide two or more motor control models which controls the motors 10, 20 in different ways. The sensor input units 33, 34 respectively receive signals indicating operation speed, output torque and temperature of the motors 10, 20. Such signals are fed back into the central control device 30.

The output control units 35, 36, under the control of the central control device 30, applies control signals to the motors 10, 20 to control the operation of the motors 10, 20. The signals control electricity supplied from the battery to the motors 10, 20 thereby controlling the operation speed and the output torque/power of the motors 10, 20. The output control unit 37 outputs signals to a rider's panel to indicate the operation condition to the rider.

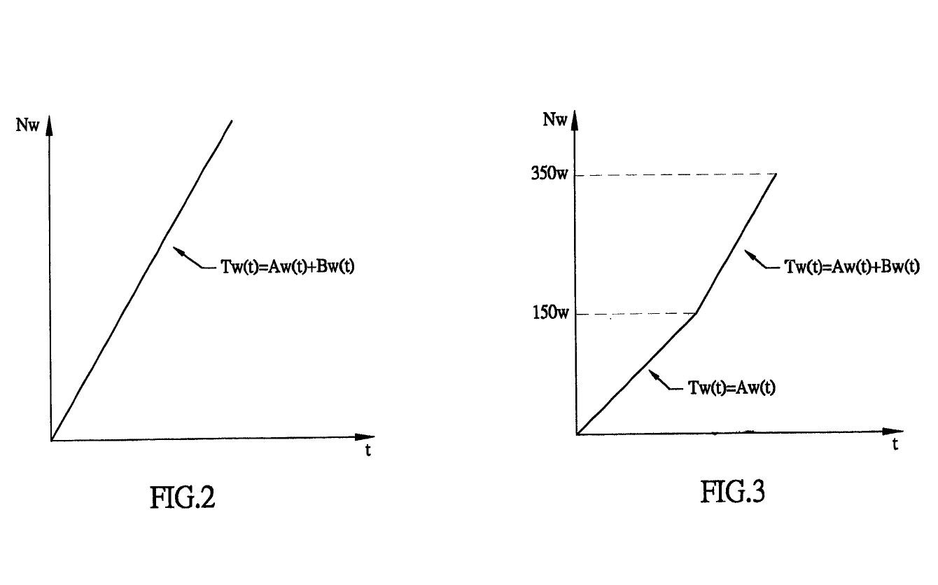

Also referring to FIGS. 2 and 3, two examples of the motor control models performed by the central control device 30 over the motors 10, 20 are respectively shown. In the embodiment illustrated, the models are performed by the control software executed in the central control device 30. These models may be carried out individually or in combination. The control software can be any known software or can be developed by those having ordinary skill in computer software. Thus further discussion will not be given.

In the motor control model of FIG. 2, the output power of motors 10, 20 is indicated by functions A_{w}(t) and B_{w}(t). Total output power of the motors 10, 20 is T_{w}(t)=A_{w}(t)+B_{w}(t). A plot of the functions A_{w}(t), B_{w}(t) and T_{w}(t) is shown in FIG. 2 wherein the abscissa is time “t” and the ordinate is power “N_{W}(t)” required to drive the motorcycle or bicycle. In this model, it is assumed that the torque required is linearly proportional to time elapsed. In an actual operation, the functions A_{w}(t) and B_{w}(t) may be varied according to different requirements. For example, the output power of the second motor 20 may be designed to be greater than that of the first motor 10 for enhancing uphill movement of the motorcycle or the bicycle.

In the model shown in FIG. 3, the total output power T_{w}(t) is defined in different way, as shown in the following formula:

T_{w}(t)=A_{w}(t)0<N_{w}(t)≦150 watts, and

T_{w}(t)=A_{w}(t)+B_{w}(t)150 watts<N_{w}(t)≦350 watts

In this way, the power consumption is set in a more reasonable distribution between the front and rear wheels. When the power required in below 150 watts, which means the vehicle can be easily moved, only one motor, the first motor 10, is activated and the second motor 20 is deactivated. When the power requirement exceeds 150 watts, the second motor 20 is also activated, which together with the first motor 10, provides a sufficient power to drive the vehicle, such moving the vehicle uphill. An unnecessary consumption of electrical power in a low power requirement condition can be avoided by the model shown in FIG. 3 for in the low power requirement condition, only one motor is operated.

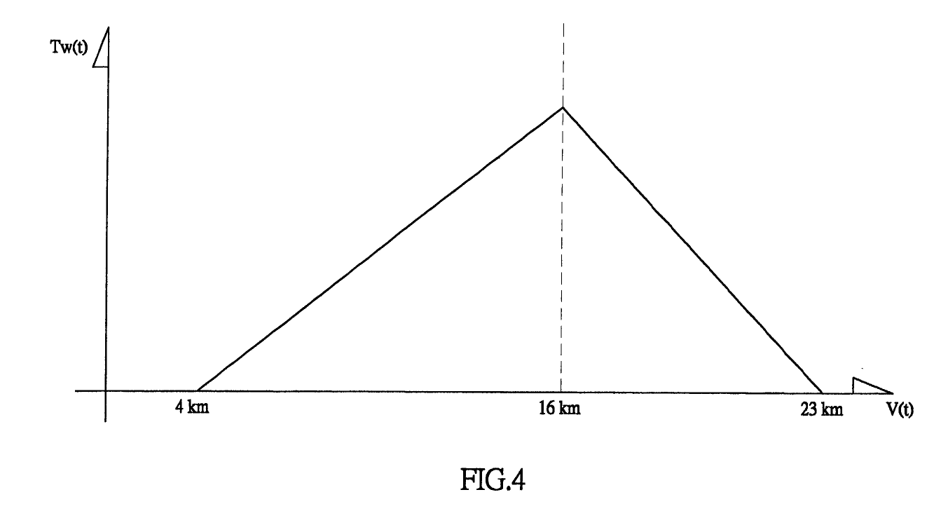

Also referring to FIG. 4, to more efficiently operate the motors 10, 20, in accordance with the present invention, besides power requirement, the output torque T_{w}(t) of the motors 10, 20 is also determined by the moving speed V(t) of the vehicle. As shown in FIG. 4, in an initial phase where the vehicle is just to move, namely the speed of the vehicle is below 4 km/h, the motors 10, 20 are deactivated. In other words, no power is supplied to the wheels from the motors 10, 20. Such a design is to prevent a rider from being hurt by the bicycle accidentally jumping to a high speed caused by the motors. Thereafter, at a low speed phase which follows the initial phase and ranging between 4-16 km/h, the output torque T_{w}(t) is regulated to be substantially linearly proportional to the speed V(t). At a high speed phase, the vehicle speed exceeding 16 km/h, the output power of the motors 10, 20 is gradually decreased with the speed of the vehicle in a negative proportional fashion. At a final phase, the speed exceeding 23 km/h, the motors 10, 20 are deactivated again whereby the rider can freely rides the bicycle and completely controls the vehicle. This ensures the safety of the rider.

It is certainly possible to modify or replace the model shown in FIG. 4. Other models of controlling the motors based on the speed of the vehicle can be used to fit actual requirement of the operation of the vehicle.

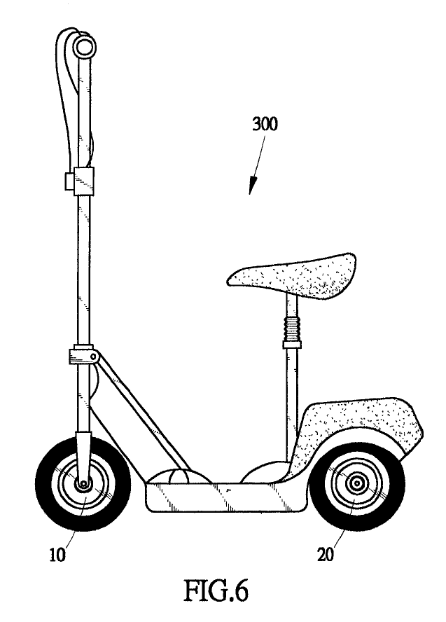

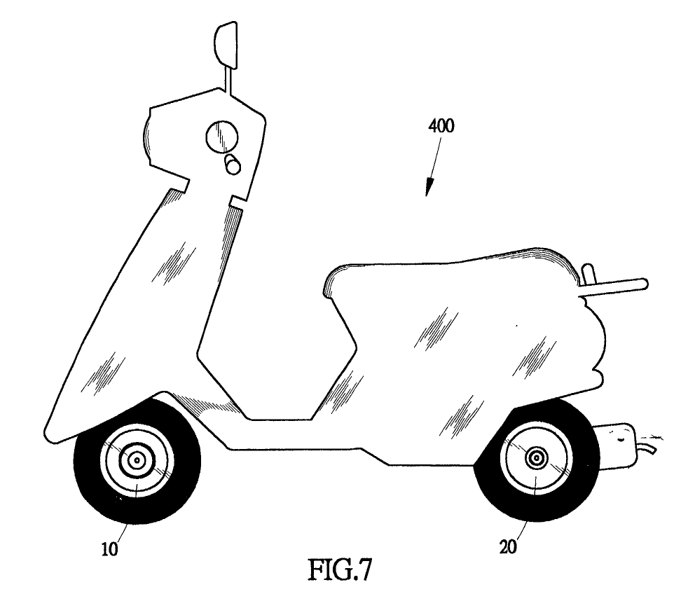

FIGS. 5-7 show applications of the present invention in a bicycle, a scooter and a motorcycle. In the example of FIG. 5, two motors 10, 20 are respectively mounted in the front and rear wheels of a bicycle 200. Similarly, in the example of FIG. 6, two motors 10, 20 are respectively mounted in two wheels of a scooter 300 and in the example of FIG. 7, two electrical motors 10, 20 are mounted in two wheels of a fuel operated motorcycle 400. By adding electrical motors to a fuel operated motorcycle, the motorcycle can be selectively driven electrically or by fossil fuel. By mounting a motor in each of the front and rear wheels of a two-wheel vehicle, a force balance can be obtained, while operation efficiency of the electrically operated vehicle may be substantially enhanced.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. A dual motor driving control system of a vehicle having first and second wheels comprising
first and second motors adapted to be respectively and mechanically coupled to the first and second wheels of the vehicle for separately driving the first and second wheels; and
at least a central control device selectively performing at least one predetermined motor control model, the central control device comprising output control units electrically coupled to the motors to control operations of the motors based on the at least one motor control model.

2. The dual motor driving control system as claimed in claim 1, wherein the central control device comprises a single-chip microprocessor.

3. The dual motor driving control system as claimed in claim 1, wherein the central control device comprises an output control unit adapted to be coupled to and providing readings to displaying units of the vehicle for displaying the readings.

4. The dual motor driving control system as claimed in claim 1, wherein the motors are rim motors.

5. The dual motor driving control system as claimed in claim 1, wherein the central control device comprises sensor input units adapted to be coupled to sensors of the vehicle for receiving operation signals therefrom and applying the signals to the central control device.

6. The dual motor driving control system as claimed in claim 5, wherein the sensor input units are adapted to receive signals representing rotational speeds and output torques of the motors.

7. The dual motor driving control system as claimed in claim 5, wherein the sensor input units are adapted to receive signals indicating meter readings of the vehicle.

8. The dual motor driving control system as claimed in claim 5, wherein the sensor input units are adapted to receive signals representing fuel supplied to a fossil fuel engine of the vehicle.

9. The dual motor driving control system as claimed in claim 5, wherein the sensor input units are adapted to receive signals representing pedaling torque applied to the vehicle.
